(19) United States
(12) Patent Application Publication
(10) Pub. No.: US 2025/0187023 A1
(43) Pub. Date: Jun. 12, 2025

(54) ORGANIC NOZZLE

(71) Applicant: Kohler Mira Limited, Cheltenham (GB)

(72) Inventors: Prasanth Jayakumar, Maharashtra (IN); Jason Kwacz, Kohler, WI (US); Robin Whitfield, Cheltenham, Gloucestershire (GB)

(21) Appl. No.: 19/055,197

(22) Filed: Feb. 17, 2025

Related U.S. Application Data
(63) Continuation of application No. 18/597,751, filed on Mar. 6, 2024.
(60) Provisional application No. 63/559,360, filed on Feb. 29, 2024.
(60) Provisional application No. 63/490,901, filed on Mar. 17, 2023.

(51) Int. Cl. B05B 1/26; B05B 1/16; B05B 1/18

(52) U.S. Cl. CPC B05B 1/26; B05B 1/16; B05B 1/185

(57) ABSTRACT

Provided herein is a showerhead that may include inlets, inlet channels, and nozzles. The inlets may provide different media to the showerhead. The inlet channels may be connected to the inlets, such that the media flowing into the inlets flows through the inlet channels. The nozzles may include outlet channels, each of which are operably coupled to one of the inlet channels. As one example, the inlets may provide a first media (air) and a second media (water). When the first media mixes with the second media into an output, the flow rate of the output is greater than the flow rate of the second media. Even when a decreased water flow rate is used, a user perceives a high flow rate due to the introduction of air into the water.

### CROSS-REFERENCE TO RELATED APPLICATIONS

The present application is a continuation of U.S. patent application Ser. No. 18/597,751, filed Mar. 6, 2024, entitled, “DIRECTIONAL WATER NOZZLE VIA FLOW CONTROL OF IMPINGING JETS,” which claims priority to U.S. Provisional Patent Application No. 63/490,901, filed Mar. 17, 2023, entitled, “DIRECTIONAL WATER NOZZLE VIA FLOW CONTROL OF IMPINGING JETS,” and U.S. Provisional Patent Application No. 63/559,360, filed Feb. 29, 2024, entitled, “ORGANIC NOZZLE,” the entire contents of which are hereby incorporated by reference.

### BACKGROUND

Flow control and temperature control of water are important in the bathing industry. Users tend to prefer showerheads, faucets, and nozzles that include various modes that provide different flow streams. However, providing higher water pressure to showerheads traditionally involves supplying a higher volume of water. Therefore, high water pressure can result in higher utility payments, greater water usage and/or waste, and other undesirable outcomes. Accordingly, there is a need for a showerhead that provides increased water pressure without a higher volume of water.

### BRIEF DESCRIPTION OF DRAWINGS

FIG. 1 is a top cross-sectional view of an example showerhead.

FIG. 2 is a bottom view of an example showerhead.

FIG. 3 is a perspective view of an example nozzle.

FIG. 4 is a cross-sectional view of an example nozzle.

FIG. 5 is a top cross-sectional view of an example showerhead.

FIG. 6 is a bottom perspective view of an example showerhead.

FIG. 7 is a bottom view of an example showerhead.

FIG. 8 is a side cross-sectional view of an example showerhead.

FIG. 9 is a cross-sectional view of an example nozzle.

FIG. 10 is a side cross-sectional view of an example heated conduit.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

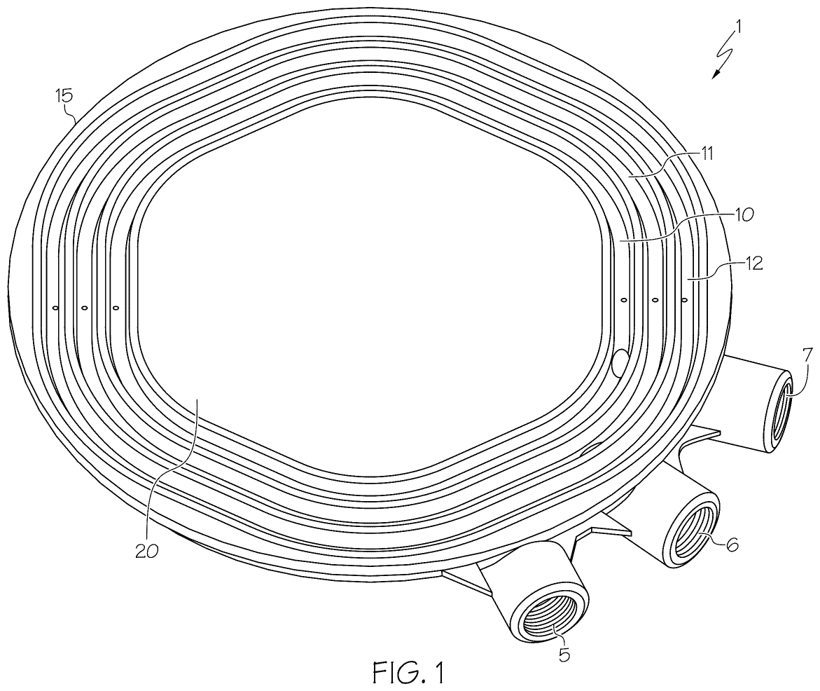

Turning first to FIG. 1, a showerhead 1 may include several inlet ports 5, 6, 7 that may be coupled to or integrally formed with the showerhead 1. As illustrated, the showerhead 1 includes a first inlet port 5, second inlet port 6, and third inlet port 7. The inlet ports 5, 6, 7 may be connected to a media input, and the inlet ports 5, 6, 7 may input any media (e.g., water, air, heated air, compressed air, hydrogen, ozone, essential oils, scented fluids, shampoo, conditioner, or any other fluid or gas) into the showerhead 1. As one example, each of the inlet ports 5, 6, 7 may be connected to water inputs in order to input water into the showerhead 1. As another example, the first and third inlet ports 5, 7 may be connected to water inputs in order to input water into the showerhead 1, while the second inlet port 6 may be connected to a compressed air input in order to input compressed air into the showerhead 1.

Each of the inlet ports 5, 6, 7 may be connected to one of a plurality of inlet channels 10, 11, 12. Media from the first inlet port 5 may travel along a path of a corresponding first inlet channel 10; media from the second inlet port 6 may travel along a path of a corresponding second inlet channel 11; and media from the third inlet port 7 may travel along a path of a corresponding third inlet channel 12. As such, the media inputted to the showerhead 1 via the first inlet port 5 may remain separated from the media inputted to the showerhead 1 via the second and third inlet ports 6, 7 (the same is true for the media from each of the inlet ports remaining separated from the other inlet ports). The inlet channels 10, 11, 12 may be positioned along an outside edge 15 within an interior 20 of the showerhead 1. The inlet channels 10, 11, 12 may be positioned in any suitable manner in the showerhead 1.

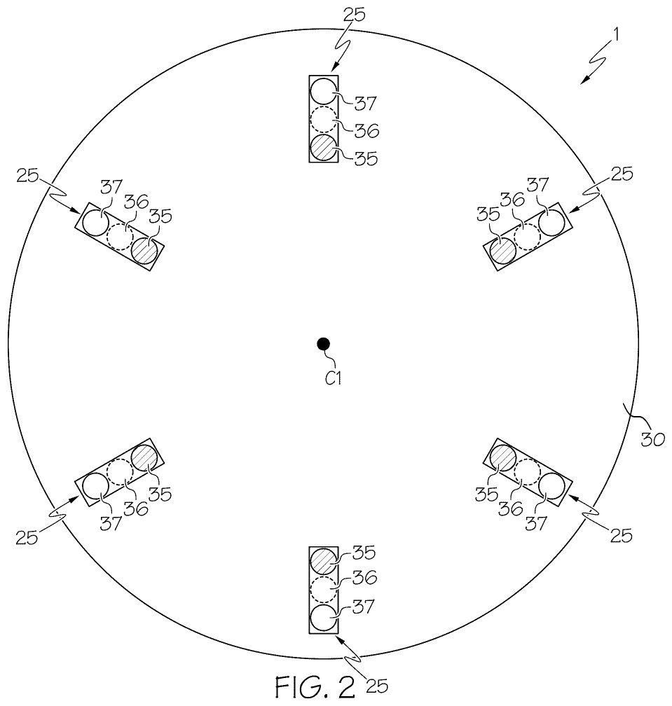

Upon entering the showerhead 1 via the inlet ports 5, 6, 7, media may travel out of the showerhead 1 via a plurality of nozzles 25, as illustrated in FIG. 2. The plurality of nozzles 25 may be positioned in any suitable manner on a faceplate 30 of the showerhead 1. As one example, the plurality of nozzles 25 may be positioned on the faceplate 30 of the showerhead 1. The plurality of nozzles 25 may be aligned along the plurality of inlet channels 10, 11, 12. The plurality of nozzles 25 may be angled in any suitable manner, and as one example, each of the plurality of nozzles 25 may be angled 5 to 10° outwards from a center point C1 of the faceplate 30.

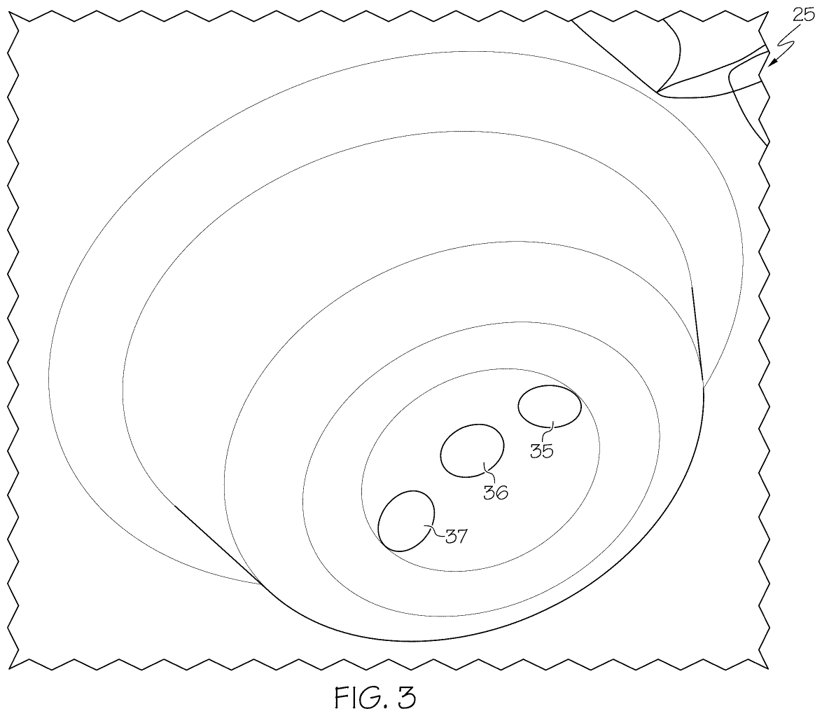

Each of the plurality of nozzles 25 may include a first outlet channel 35, second outlet channel 36, and third outlet channel 37. Each of the plurality of outlet channels 35, 36, 37 may be any shape. As one example, each of the plurality of outlet channels 35, 36, 37 may be circular. When circular, the plurality of outlet channels 35, 36, 37 may have any diameter. As one example, each of the plurality of outlet channels 35, 36, 37 may have a diameter of 1.2 to 1.5 mm. Each of the plurality of outlet channels 35, 36, 37 may be associated with one of the plurality of inlet channels 10, 11, 12. As one example, the media flowing through the first inlet channel 10 may flow out of the showerhead 1 via the first outlet channel 35, the media flowing through the second inlet channel 11 may flow out of the showerhead 1 via the second outlet channel 36, and the media flowing through the third inlet channel 12 may flow out of the showerhead 1 via the third outlet channel 37. The plurality of nozzles 25 and plurality of outlet channels 35, 36, 37 may be designed similarly to a nozzle 25 as illustrated in FIG. 3.

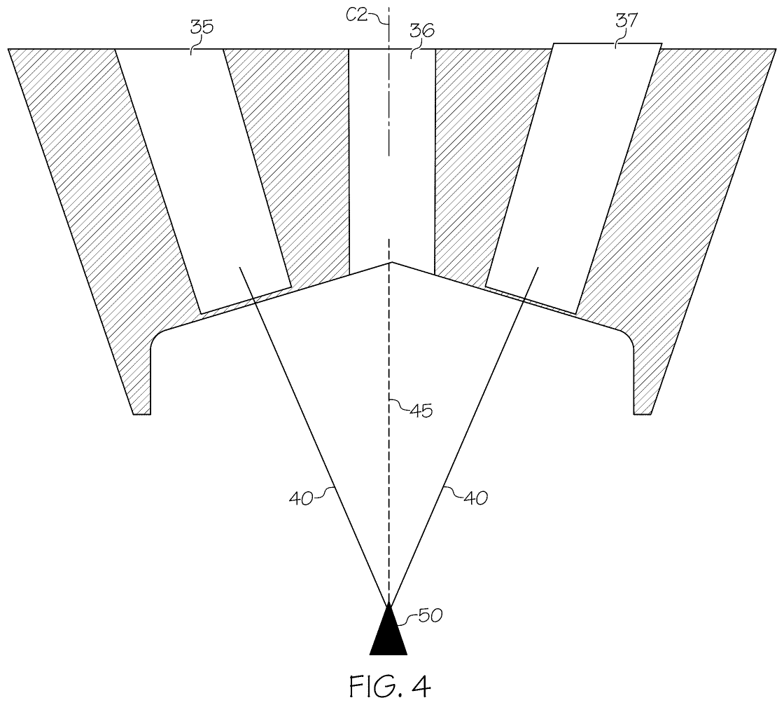

Turning to FIG. 4, the plurality of outlet channels 35, 36, 37 may be angled in any suitable manner. As one example, the outer outlet channels 35 and 37 may be angled 20° from a center line C2 of the nozzle 25, and the center outlet channel 36 may be parallel with the center line C2 of the nozzle 25. Different media may flow out of the nozzle 25 via the plurality of outlet channels 35, 36, 37. Any types of media may flow through the outlet channels 35, 36, 37, and media may or may not flow out of all of the outlet channels 35, 36, 37. As one example, as illustrated in FIG. 4, water 40 may flow out of the nozzle 25 from the first and third outlet channels 35, 37, while air 45 flows out of the nozzle 25 from the second outlet channel 36. In this example, the various outlet channels 35, 36, 37 may keep the water 40 and air 45 separated within the nozzle 25, but the water 40 and air 45 may mix or blend to form an output 50 after exiting the nozzle 25. Such mixing or blending may occur before the media comes into contact with a user.

Introducing air to water, as one example, may increase the force of the output 50 flowing from each nozzle 25 such that a user may perceive the sensation of a stream with higher water pressure without increasing the volume of water supplied to the showerhead 1. Thus, the addition of air or another non-water media to the stream provided by the nozzle 25 may enable a user to reduce water usage without sacrificing the quality of the experience of using the showerhead 1.

Additionally, different spray patterns may be achieved without any physical rotation or movement of any media outlets through the use of some or all of the outlet channels 35, 36, 37. As one example, the first and third outlet channels 35, 37 may be active, and media may be flowing out of the active outlet channels 35, 37. The second outlet channel 36 may be inactive, and media may not be flowing out of the inactive outlet channel 36. The output stream 50 may be angled in a manner that results from the incoming angle of each of the active outlet channels 35, 37. The streams of media from the active outlet channels 35, 37 may impinge on one another, and the resulting output stream 50 may have an angle that is between the angles of the active outlet channels 35, 37.

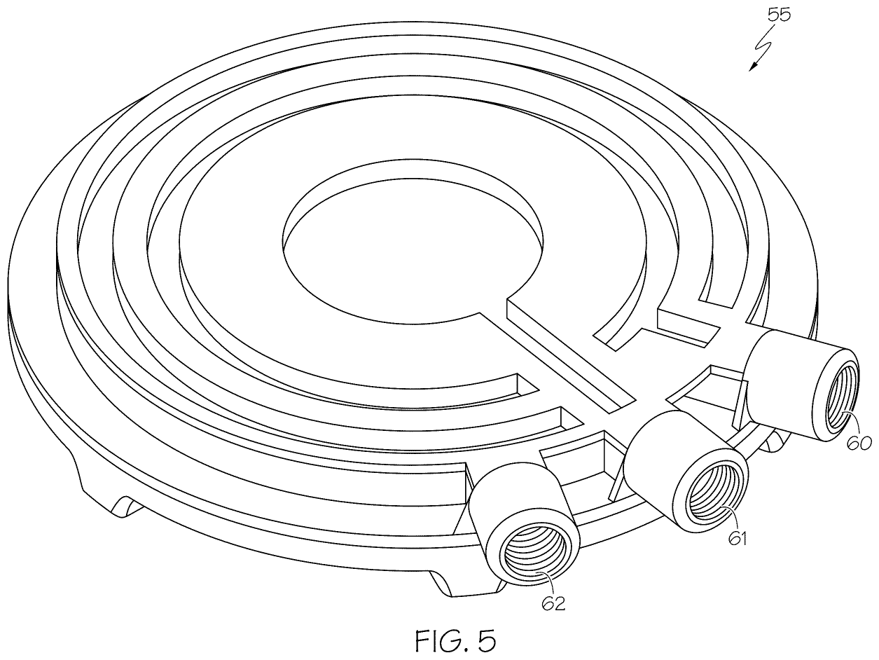

Turning now to FIG. 5, a showerhead 55 may include several inlet ports 60, 61, 62 that may be coupled to or integrally formed with the showerhead 55. As illustrated, the showerhead 55 includes a first inlet port 60, second inlet port 61, and third inlet port 62. The inlet ports 60, 61, 62 may be connected to a media input, and the inlet ports 60, 61, 62 may input any media (e.g., water, air, heated air, compressed air, hydrogen, ozone, essential oils, scented fluids, shampoo, conditioner, or any other fluid or gas) into the showerhead 55. As one example, each of the inlet ports 60, 61, 62 may be connected to water inputs in order to input water into the showerhead 55. As another example, the first and third inlet ports 60, 62 may be connected to water inputs in order to input water into the showerhead 55, while the second inlet port 61 may be connected to a compressed air input in order to input compressed air into the showerhead 55.

Each of the inlet ports 60, 61, 62 may be connected to one of a plurality of inlet channels (not illustrated). Media from the first inlet port 60 may travel along a path of a corresponding first inlet channel; media from the second inlet port 61 may travel along a path of a corresponding second inlet channel; and media from the third inlet port 62 may travel along a path of a corresponding third inlet channel. As such, the media inputted to the showerhead 55 via the first inlet port 60 may remain separated from the media inputted to the showerhead 55 via the second and third inlet ports 61, 62 (the same is true for the media from each of the inlet ports remaining separated from the other inlet ports). The inlet channels may be positioned in any suitable manner in the showerhead 55.

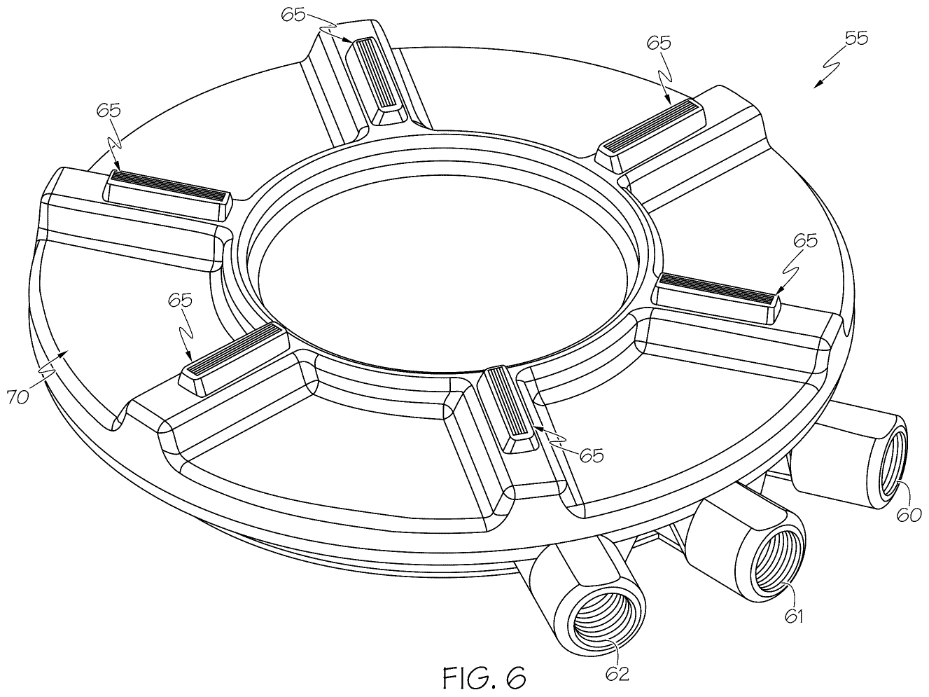

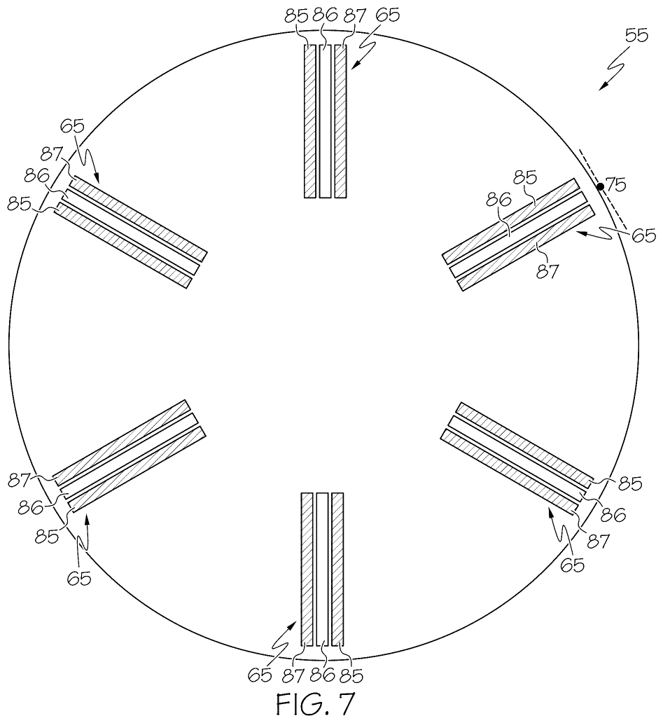

Turning to FIG. 6, upon entering the showerhead 55 via the inlet ports 60, 61, 62, media may travel out of the showerhead 55 via a plurality of nozzles 65. The plurality of nozzles 65 may be positioned in any suitable manner on a faceplate 70 of the showerhead 55. As one example, the plurality of nozzles 65 may be positioned on the showerhead 55 as illustrated in FIGS. 6 and 7. The plurality of nozzles 65 may be aligned along the plurality of inlet channels.

Turning now to FIG. 7, the plurality of nozzles 65 may be angled in any suitable manner, and as one example, each of the plurality of nozzles 65 may be positioned at, substantially, a 90° angle from its corresponding tangential point (e.g., tangential point 75) of an outer edge 80 of the faceplate 70.

Each of the plurality of nozzles 65 may include a first outlet channel 85, second outlet channel 86, and third outlet channel 87. Each of the plurality of outlet channels 85, 86, 87 may be any shape. As one example, each of the plurality of outlet channels 85, 86, 87 may be shaped as a “slot” or a rectangle. When rectangular, the plurality of outlet channels 85, 86, 87 may have any suitable size. As one example, each of the plurality of outlet channels 85, 86, 87 may have a width of, approximately, 0.4 mm and a length of 22 mm. Each of the plurality of outlet channels 85, 86, 87 may be associated with one of the plurality of inlet channels. As one example, the media flowing through a first inlet channel may flow out of the showerhead 55 via a first outlet channel 85, the media flowing through the second inlet channel may flow out of the showerhead 55 via the second outlet channel 86, and the media flowing through the third inlet channel may flow out of the showerhead 55 via the third outlet channel 87.

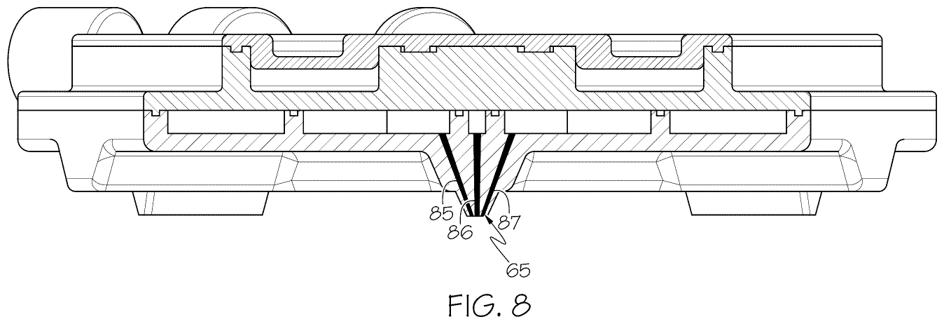

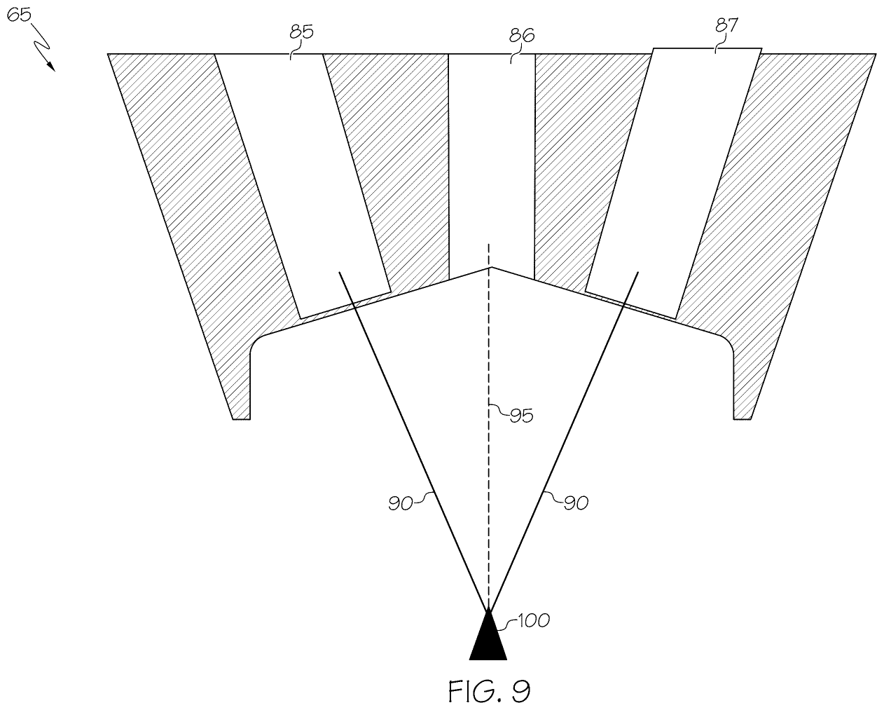

Turning to FIG. 8, media may flow out of the nozzle 65 via the plurality of outlet channels 85, 86, 87. Any types of media may flow through the outlet channels 85, 86, 87, and media may or may not flow out of all of the outlet channels 85, 86, 87. As one example, as illustrated in FIG. 9, water 90 may flow out of the nozzle 65 from the first and third outlet channels 85, 87, while air 95 flows out of the nozzle 65 from the second outlet channel 86. In this example, the various outlet channels 85, 86, 87 may keep the water 90 and air 95 separated within the nozzle 65, but the water 90 and air 95 may mix or blend to form an output 100 after exiting the nozzle 65. Such mixing or blending may occur before the media comes into contact with a user.

Introducing air to water, as one example, may increase the force of the output 100 flowing from each nozzle 65 such that a user may perceive the sensation of a stream with higher water pressure without increasing the volume of water supplied to the showerhead 55. Thus, the addition of air or another non-water media to the stream provided by the nozzle 65 may enable a user to reduce water usage without sacrificing the quality of the experience of using the showerhead 55.

Additionally, different spray patterns may be achieved without any physical rotation or movement of any media outlets through the use of some or all of the outlet channels 85, 86, 87. As one example, the first and third outlet channels 85, 87 may be active, and media may be flowing out of the active outlet channels 85, 87. The second outlet channel 86 may be inactive, and media may not be flowing out of the inactive outlet channel 86. The output stream 100 may be angled in a manner that results from the incoming angle of each of the active outlet channels 85, 87. The streams of media from the active outlet channels 85, 87 may impinge on one another, and the resulting output stream 100 may have an angle that is between the angles of the active outlet channels 85, 87.

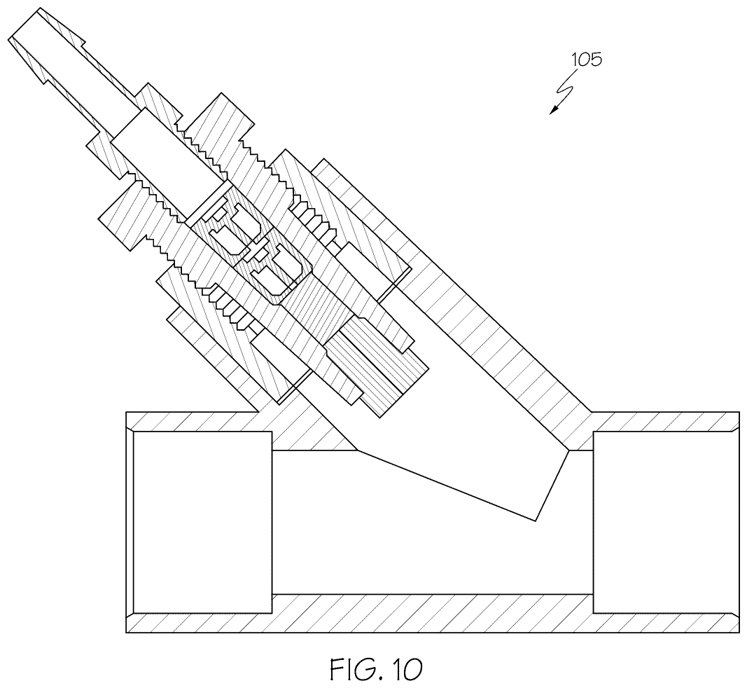

Turning to FIG. 10, a heated conduit 105 may be included in the showerhead 1, the showerhead 55, or other examples of the present invention. The heated conduit 105 may heat media within a showerhead before it is directed toward a user. For example, when the showerhead 1 or showerhead 55 provides a mixture of water and heated air to a user, the heated conduit 105 may provide the means for warming the air into heated air before directing the heated air toward a user. The heated conduit 105 may facilitate humidification of the heated air by imparting moisture to the air during heating. This humidification may, for example, increase the heat content of the heated air or improve the perceived comfort of a user when being impacted by humidified heated air as opposed to dry heated air.

The heated conduit 105 may be used to heat water or another media, and the heated conduit 105 may heat more than one type of media simultaneously. Further, the heated conduit 105 may heat a mixture containing multiple types of media. For example, the heated conduit 105 may apply heat to a mixture of air and water, rather than heating the air and water separately before they combine to form a mixture. In this way, the heated conduit may impart heat to the mixture with a more even distribution than would be possible if multiple types of media are heated separately before combining to form a mixture. For example, the heated conduit 105 may heat a mixture of multiple types of media without imparting substantially more heat to one portion of the mixture than to another. The improved heat distribution provided by the heated conduit 105 may provide a heated mixture of media to a user without producing a portion of the mixture that may scald or otherwise harm the user. The heated conduit 105 may be substantially similar in structure and function to the conduit assembly described in U.S. Pat. No. 11,331,246 assigned to Kohler Co., the entirety of which is hereby incorporated by reference.

A blow dryer may be integrated into the showerhead 1, the showerhead 55, or other examples of the present invention. The blow dryer may be utilized to assist in drying a user after showering. The blow dryer may output heated air from the showerhead 1 or showerhead 55, which may be directed through the outlets onto the user.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A showerhead comprising:
at least two inlets, wherein each of the at least two inlets provides a media to the showerhead;
at least two inlet channels, each connected to one of the at least two inlets, wherein the media from the at least two inlets flows into and through the at least two inlet channels;
a plurality of nozzles positioned on a faceplate of the showerhead, wherein each of the plurality of nozzles comprises at least two outlet channels;
wherein each of the at least two outlet channels is connected to one of the at least two inlet channels; and
wherein the media from the at least two inlets flows out of the showerhead via the plurality of nozzles.

2. The showerhead of claim 1, wherein a first inlet of the at least two inlets provides a first media of air, and wherein a second inlet of the at least two inlets provides a second media of water.

3. The showerhead of claim 1, wherein when a first media of a first inlet of the at least two inlets mixes with a second media of a second inlet of the at least two inlets into an output, a flow rate of the output is greater than a flow rate of at least one of the first media and the second media.

4. The showerhead of claim 2, wherein the first media mixes with the second media after exiting the showerhead.

5. The showerhead of claim 1, wherein the at least two inlet channels are separated from one another such that media in a first inlet channel of the at least two inlet channels is fluidly separated from a second inlet channel of the at least two inlet channels.

6. The showerhead of claim 1, wherein each of the plurality of nozzles is angled at least 5 degrees outwards from a center point of the faceplate.

7. The showerhead of claim 1, wherein each of the plurality of nozzles has a diameter of at least 1.2 mm.

8. The showerhead of claim 1, wherein an angle of an output from each of the plurality of nozzles is determined based on an average of angles of each of the at least two outlet channels.

9. A showerhead comprising:
a first inlet channel provided with a first media, wherein the first media flows into and through the first inlet channel;
a second inlet channel provided with a second media, wherein the second media flows into and through the second inlet channel; and
a plurality of nozzles comprising a first outlet channel and a second outlet channel;
wherein the first outlet channel is connected to the first inlet channel;
wherein the second outlet channel is connected to the second inlet channel;
wherein the first media flows out of the showerhead via the first outlet channel; and
wherein the second media flows out of the showerhead via the second outlet channel.

10. The showerhead of claim 9, wherein the first media is air, and the second media is water.

11. The showerhead of claim 9, wherein when the first media mixes with the second media into an output, a flow rate of the output is greater than a flow rate of at least one of the first media and the second media.

12. The showerhead of claim 9, wherein the first media mixes with the second media after exiting the showerhead.

13. The showerhead of claim 9, wherein the first and second inlet channels are separated from one another such that the first media is fluidly separated from the second media.

14. The showerhead of claim 9, wherein an angle of an output from each of the plurality of nozzles is determined based on an average of angles of each of the first and second outlet channels.

15. The showerhead of claim 9, further comprising a third inlet channel provided with a third media;
wherein the third media flows into and through the third inlet channel;
wherein the plurality of nozzles further comprises a third outlet channel connected to the third inlet channel; and
wherein the third media flows out of the showerhead via the third outlet channel.

16. The showerhead of claim 9, further comprising a faceplate, wherein each of the plurality of nozzles is positioned at a 90 degree angle from its corresponding tangential point of an outer edge of the faceplate.

17. A showerhead comprising:
a first inlet providing a first media to the showerhead;
a second inlet providing a second media to the showerhead;
a third inlet providing a third media to the showerhead;
a first inlet channel connected to the first inlet, wherein the first media flows into and through the first inlet channel;
a second inlet channel connected to the second inlet, wherein the second media flows into and through the second inlet channel;
a third inlet channel connected to the third inlet, wherein the third media flows into and through the third inlet channel; and
a plurality of nozzles, wherein each of the plurality of nozzles comprises a first outlet channel, a second outlet channel, and a third outlet channel;
wherein the first outlet channel is connected to the first inlet channel, wherein the second outlet channel is connected to the second inlet channel, and wherein the third outlet channel is connected to the third inlet channel; and
wherein the first, second, and third media flows out of the showerhead via the first, second, and third outlet channels, respectively.

18. The showerhead of claim 17, wherein the first media is air, and wherein the second media is water.

19. The showerhead of claim 18, wherein when the first media mixes with the second media into an output, a flow rate of the output is greater than a flow rate of the second media.

20. The showerhead of claim 17, wherein the first, second, and third inlet channels are separated from one another such that the first, second, and third media are each fluidly separated from one another, and wherein the first, second, and third media after exiting the showerhead.
